(19) United States
(12) Patent Application Publication
(10) Pub. No.: US 2014/0195569 A1
(43) Pub. Date: Jul. 10, 2014

(54) STATUS DISPLAY DEVICE, STORAGE MEDIUM, STATUS DISPLAY SYSTEM

(71) Applicant: Kabushiki Kaisha Toshiba, Tokyo (JP)

(72) Inventor: Satoshi Uchino, Koganei-shi (JP)

(73) Assignee: Kabushiki Kaisha Toshiba, Tokyo (JP)

(21) Appl. No.: 14/017,504

(22) Filed: Sep. 4, 2013

Related U.S. Application Data
(63) Continuation of application No. PCT/JP2013/057873, filed on Mar. 19, 2013.

(30) Foreign Application Priority Data
Jan. 8, 2013 (JP) 2013-000940

(51) Int. Cl. G06F 17/30

(52) U.S. Cl. CPC G06F 17/3007
USPC 707/821

(57) ABSTRACT

According to one embodiment, a status display device includes an input module and a display module. The input module is configured to input a measurement file includes file information indicating a file in a measurement target, access information indicating access to the file, and time information. The display module is configured to display a status of the measurement target based on the measurement file input to the input module.

### CROSS REFERENCE TO RELATED APPLICATIONS

This application is a Continuation Application of PCT Application No. PCT/JP2013/057873, filed Mar. 19, 2013 and based upon and claiming the benefit of priority from Japanese Patent Application No. 2013-000940, filed Jan. 8, 2013, the entire contents of all of which are incorporated herein by reference.

### FIELD

Embodiment described herein relate generally to a status display device, storage medium, and status display system which display a status of a system such as a computer.

### BACKGROUND

From the past, a status display device displaying a status of a computer and serving as a trace system has been generally used. The status display device creates trace data based on a processing status in a measurement target. The status display device can display a status of the measurement target based on the created trace data.

The status display device stores the created trace data in a buffer etc. The status display device reads the trace data stored in a ring buffer etc., and creates a file (measurement file) of the trace data concerning the measurement target.

For example, the status display device records a change in status for every processing item (every process) in the measurement target as the trace data.

In this case, the status display device can display the status of the measurement target for every processing item based on the trace data. For example, the status display device can display an immediately previous status of the measurement target by managing changes in status for a certain processing item by using a stack structure.

However, existing display technologies using the trace file do not provide a function of performing display on a per file basis. For example, although display of access timing for a file will be a hint of debugging/tuning and is demanded, a means that meets this demand has not been known yet.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram for describing an example of a configuration of a status display system according to an embodiment.

FIG. 2 is an explanatory diagram describing a function of the status display system illustrated in FIG. 1.

FIG. 3 is a diagram illustrating an example of an outline of a display screen of a display device 260 according to the same embodiment.

FIG. 4 is a diagram illustrating another example of the outline of the display screen of the display device 260 according to the same embodiment.

FIG. 5 is a diagram illustrating a status of measurement processing of an operating program used for the embodiment.

FIG. 6 is a diagram illustrating a table used for the embodiment.

FIG. 7 is a diagram illustrating an example of a portion of a measurement file 440 used for the embodiment.

### DETAILED DESCRIPTION

Hereinafter, a status display device, storage medium, and status display system according to embodiments are described in detail with reference to the drawings.

In general, according to one embodiment, a status display device includes an input module and a display module. The input module is configured to input a measurement file comprising file information indicating a file in a measurement target, access information indicating access to the file, and time information. The display module is configured to display a status of the measurement target based on the measurement file input to the input module.

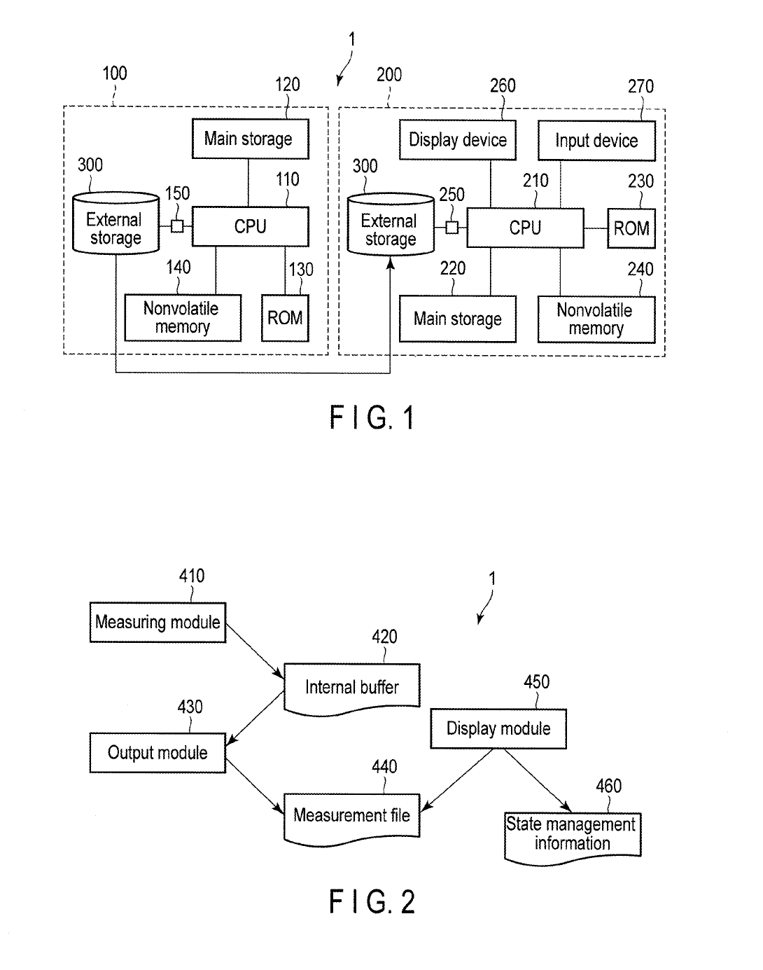

First, FIG. 1 is a block diagram for describing an example of a configuration of a status display system 1 according to an embodiment.

FIG. 1 illustrates a hardware configuration of the system. The status display system 1 includes a processing device 100 which is the whole system as a measurement target, and a status display device 200 which performs status display processing.

The processing device 100 includes a CPU 110, a main storage 120, a ROM 130, a nonvolatile memory 140, and an interface 150. An external storage 300, such as an HDD or a USB memory, is connected to the interface 150.

The CPU 110 includes an arithmetic element etc, which perform various arithmetic processing. The CPU 110 implements various functional modules by executing programs stored in the ROM 130 or nonvolatile memory 140.

The processing device 100 may include hardware which has functions equivalent to the functional modules, instead of the programs stored in the ROM 130 or nonvolatile memory 140.

The main storage 120 functions as a work memory of the CPU 110. That is, the CPU 110 temporarily stores processing results of the arithmetic processing, data which is read from the ROM 130 or nonvolatile memory 140, data to be written into the external storage 300, etc.

The ROM 130 includes a control program which controls the processing device 100. The ROM 130 further includes processing programs for executing applications etc. The nonvolatile memory 140 is a memory which stores various kinds of setup information.

The interface 150 is an interface allowing connection to various devices. For example, the interface 150 includes a USB port, an S-ATA port, a LAN port, or a memory reader/writer to which various kinds of storages, such as a memory card, can be connected, etc.

The external storage 300 is a storage, such as an HDD, a USB memory, or a memory card. The external storage 300 is connected to the interface 150 of the processing device 100. Thus, the CPU 110 can perform data writing, data reading, or other processing with respect to the external storage 300. The external storage 300 may be any kind of a storage medium as long as it is a nonvolatile storage medium.

When each of the processing device 100 and the status display device 200 includes a communication interface which enables mutual communication with each other, the status display system 1 can replaces the external storage 300 with a storage installed in the processing device 100, such as an HDD, for example, an NAS (Network Attached Storage) on a LAN. When a USB memory is used as the external storage 300, it may be removed from the processing device 100 and then inserted into the status display device 200.

The CPU 110 starts up various items (processes) by executing programs stored in the ROM 130, nonvolatile memory 140, or the like, or utilizing hardware equivalent to the programs. The process enters various statuses (called status entrance) or comes out of various statuses (called status exit).

By performing processing described below, the CPU 110 stores the status entrance and the status exit for each item, and creates a file (measurement file) of trace data.

The status display device 200 includes a CPU 210, a main storage 220, a ROM 230, a nonvolatile memory 240, an interface 250, a display device 260 such as an LCD, and an input device 270 such as a keyboard or a mouse.

The CPU 210 includes an arithmetic element etc, which perform various arithmetic processing. The CPU 210 implements various functional modules by executing programs stored in the ROM 230 or nonvolatile memory 240.

In addition, the status display device 200 may include hardware having functions equivalent to the functional modules instead of programs stored in the ROM 230 or nonvolatile memory 240.

The main storage 220 functions as a work memory of the CPU 210. That is, the CPU 210 temporarily stores processing results of arithmetic processing in the main storage 220. The CPU 210 temporarily stores data which is read from the ROM 230, nonvolatile memory 240, or external storage 300 in the main storage 220. The CPU 210 temporarily stores data to be written into the external storage 300, etc. in the main storage 220.

The ROM 230 includes a control program which controls the status display device 200. The ROM 230 includes processing programs for executing applications etc. The nonvolatile memory 240 is a memory which stores various kinds of setup information.

The interface 250 is an interface allowing connection to various devices. For example, the interface 250 includes a USB port, an S-ATA port, a LAN port, or a memory reader/writer to which various storage media such as a memory card can be connected.

That is, the external storage 300 connected to the processing device 100 is connectable to the interface 250 of the status display device 200. When the external storage 300 is connected to the interface 250 of the status display device 200, the CPU 210 can perform data writing, data reading, or other processing with respect to the external storage 300.

The display device 260 is a displaying means including a liquid crystal display, an organic electroluminescence display, or any kind of display device which can display an image according to a video signal, for example. The display device 260 displays an image based on a signal received from the CPU 210.

The input device 270 is an input means including an operational key, a keyboard, a mouse, or any type of input device which can generate an operation signal according to an operational input, for example.

The input device 270 generates an operation signal according to an operational input. The input device 270 supplies the operation signal to the CPU 210.

The CPU 110 and CPU 210 may include a register etc. In such a case, the CPU 110 and CPU 210 may store data which is frequently referred to in the register instead of the main storages 120 and 220.

FIG. 2 is an explanatory diagram describing functions of the status display system 1 illustrated in FIG. 1. The status display system 1 includes various modules which are started by being executed by the CPU 110 of the processing device 100 or the CPU 210 of the status display device 200, and a storage area which stores data.

The status display system 1 includes a measuring module 410, an internal buffer 420, an output module 430, a storage area for storing a measurement file 440, a display module 450, and a storage area for storing status management information 460.

Among these, the measuring module 410, the internal buffer 420, the output module 430, and the measurement file 440 are modules in connection with the measurement in the status display system 1. The measuring module 410 writes a measurement result in the measurement file 440 via a certain means according to the present embodiment. The display module 450 and status management information 460 are modules in connection with the display in the status display system 1. The display module 450 reads the measurement file 440, displays a screen while updating the status management information 460.

Although the present embodiment describes a configuration in which the processing device 100 includes the measuring module 410, the internal buffer 420, and the output module 430, and the status display device 200 includes the display module 450 and the storage area for storing status management information 460; the present embodiment is not limited to this configuration. Whichever of the processing device 100 and status display device 200 may include each of the functions. The processing device 100 and status display device 200 may be integrally formed.

That is, the measuring module 410, an internal buffer 420, an output module 430, a storage area for storing the measurement file 440, a display module 450, and a storage area for storing the status management information 460 are included in one device.

The measuring module 410 measures status changes, such as status entrance and status exit for each item.

The measuring module 410 includes at least a function of counting time, and a function of recognizing the status of the process executed in the measurement target. That is, when a status of an item executed by the CPU 110 changes, the measuring module 410 stores trace data, such as a name of the item which has changed in the status, time at which the status change has occurred, the content of the status change, etc. in the internal buffer 420.

The internal buffer 420 is, for example, a ring buffer provided in the main storage 120.

The output module 430 reads the trace data from the internal buffer 420, and stores the trace data as a file in the external storage 300. That is, the output module 430 creates the measurement file 440 within the external storage 300.

The CPU 110 recognizes each of a writing position and a reading position on the internal buffer 420. That is, the measuring module 410 writes the trace data, starting from the writing position recognized. The measuring module 410 moves a write pointer indicating the writing position to a last portion of the trace data which has been written.

The output module 430 reads the trace data, starting from the reading position recognized. The output module 430 moves a read pointer indicating the reading position to a last portion of the trace data which has been read.

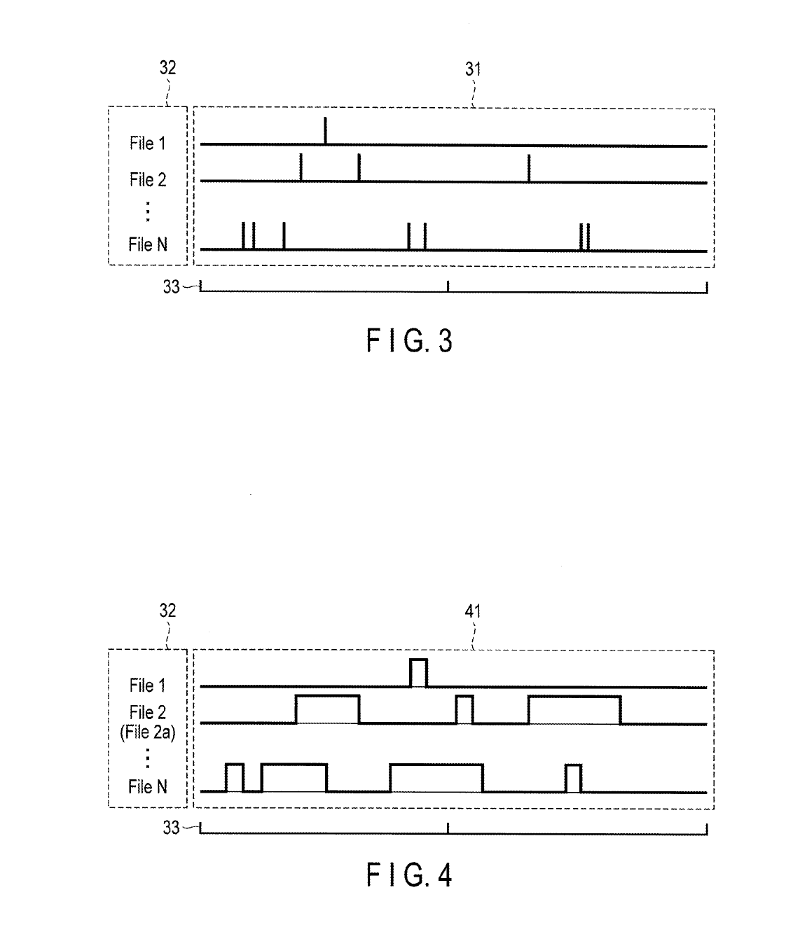

FIG. 3 illustrates an outline of a display screen of the display device 260. It is assumed that the measurement file 440 which is a result of the measurement performed by the processing device 100 is stored in the external storage 300. Time points at which access to each of a plurality of file items (names) 32 occurs are plotted on lines based on the contents of the measurement file 440. In this manner, a behavior of access for each time axis can be indicated (31). A period of lapsed time is indicated on a time axis 33. The time axis 33 can be arbitrarily scaled. For example, the time axis 33 is scaled in microseconds order and is displayed on screen.

Although FIG. 4 is similar to FIG. 3, FIG. 4 further illustrates an operation session (41) for access in an operating system side.

FIG. 5 illustrates a status of measurement processing of an operating program. As illustrated here, a plurality of measurement points (Step S52 and Step S54) are interleaved between usual processing steps (Step S51 and Step S53). A time, a process identifier, and other information are stored by the measuring module 410 whenever each measurement point passes. The other information may include a file name and a file identifier.

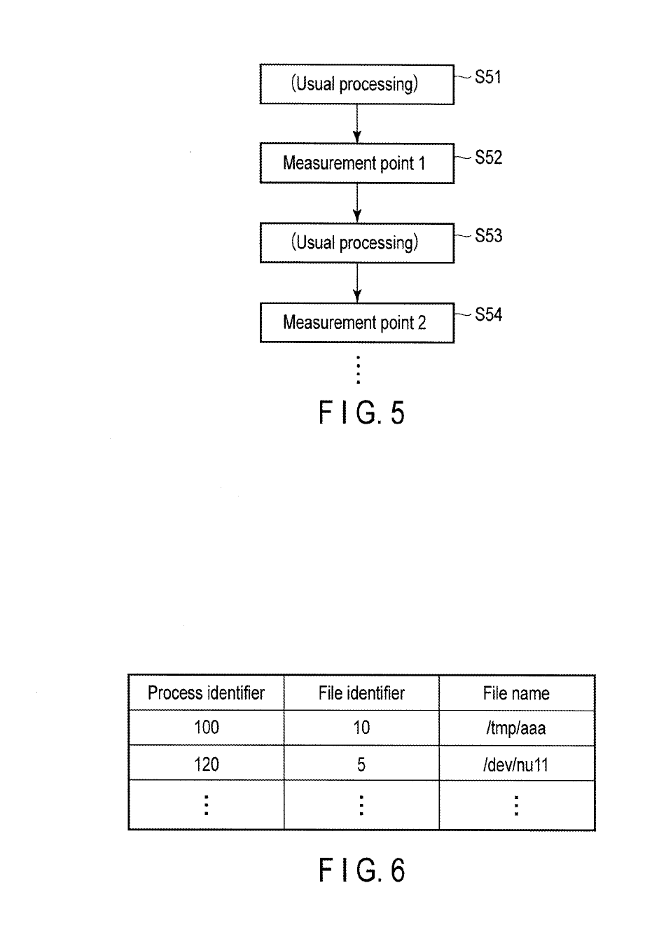

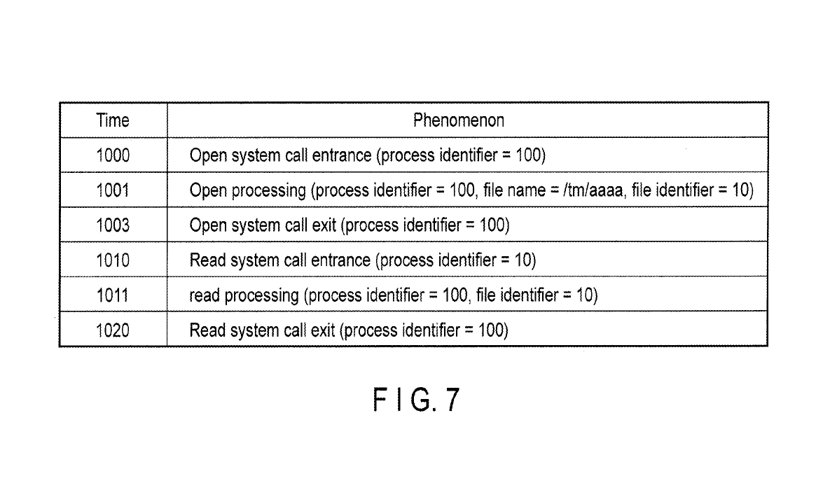

FIG. 7 illustrates an example of a portion of the measurement file 440. In the display module 450, since it is determined that a process identifier 100 and a file identifier 10 can be converted into a file name/tmp/aaa based on a phenomenon at time 1001, a table illustrated in FIG. 6 which includes the status management information 460 is updated.

When a phenomenon at time 1011 is displayed, a file name is acquired from the table illustrated in FIG. 6, and a plot is placed on the line corresponding to the file.

According to the display method of FIG. 3, open processing at time 1001 and read processing at time 1011 are displayed by a vertical line in the example of FIG. 7.

According to the display method of FIG. 4, a session from an open system call entrance at time 1000 to an open system call exit at time 1003 and a session from a read system call entrance at time 1010 to a read system call exit at time 1020 are respectively displayed in rectangles in the example of FIG. 7.

When a file name as file information cannot be obtained by conversion, a set of a file identifier and a process identifier is displayed instead of the file name. There is a case where event information cannot be obtained, or open processing has been already finished at the time of beginning to obtain.

Although conventionally there is a tool which arranges CPUs (refer to item (4) below) or processes in a vertical axis, there is no tool which arranges files.

According to the present embodiment, an analysis approaching to an access to a file is achieved.

According to the embodiments, following items are provided.

(1) There is provided a trace file display method which is a method of recording various phenomena which occur in a computer system and times at which the phenomena occur, and is also a method of displaying a trace file recorded. A file name or a file identifier as a phenomenon of access to a file, and a process identifier of a process of accessing a file are recorded in the trace file. A table which converts the file identifier and the process identifier into the file name is provided. The method includes a step of converting the file identifier and the process identifier into the fine name when the fine name is not recorded. File access times are plotted with the vertical axis indicating file names and the lateral axis indicating times.

(2) When the conversion to the file name is not possible in item (1), a set of the file identifier and the process identifier is displayed instead of the file name.

(3) When a plurality of file names are allocated to the same subject on a computer system serving as a measurement target (for example, a plurality of links such as shortcuts which are created due to a certain requirement of a program are created) in item (1), link information is recorded in the trace file, and a file group concerning the same subject is displayed as one item based on recording link information (for example, (file 2a) in FIG. 4 is a link to file 2).

(4) The file includes not only an ordinary file but a virtual file used by an operating system. For example, the file includes a device file (for example, /dev/i2c-* concerning IIC wherein * is an integer such as 0, 1, 2, etc.) for accessing a device driver, and a pseudo file system for accessing various information on a system. The file can simultaneously overlook use status of each CPU or file access of each CPU, such as interruption timing.

(5) A unit of the phenomenon of the file access is a service (system call) provided by an operating system.

(6) For a display, a session from an entrance to an exit of a system call is displayed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A status display device comprising:
an input module configured to input a measurement file comprising file information indicating a file in a measurement target, access information indicating access to the file, and time information; and
a display module configured to display a status of the measurement target based on the measurement file input to the input module.

2. The status display device of claim 1, wherein the file information comprises a set of a file name or a file identifier and a process identifier.

3. The status display device of claim 1, wherein a unit of the access information is a system call of an operating system of the measurement target.

4. A computer-readable, non-transitory storage medium having stored thereon a computer program which is executable by a computer, the computer program controlling the computer to execute functions of:
displaying a status of a measurement target, based on a measurement file input to a status display device, the measurement file comprising at least file information indicating a file in the measurement target, access information indicating access to the file, and time information.

5. The storage medium of claim 4, wherein the file information comprises a set of a file name or a file identifier and a process identifier.

6. The storage medium of claim 4, wherein a unit of the access information is a system call of an operating system of the measurement target.

7. A status display system comprising:
a measuring module configured to generate a measurement file including file information indicating a file, access information indicating access to the file, and time information, based on a change in a status in a measurement target; and
a display module configured to display the status in the measurement target based on the measurement file generated by the measuring module.

8. The status display system of claim 7, wherein the file information comprises a set of a file name or a file identifier and a process identifier.

9. The status display system of claim 7, wherein a unit of the access information is a system call of an operating system of the measurement target.
